(19) United States
(12) Patent Application Publication
(10) Pub. No.: US 2012/0229515 A1
(43) Pub. Date: Sep. 13, 2012

(54) Auto-Orientation of Display of a Power Distribution Unit

(76) Inventor: Huimin Cao, Belle Maed, NJ (US)

(21) Appl. No.: 13/269,210

(22) Filed: Oct. 7, 2011

Related U.S. Application Data
(60) Provisional application No. 61/390,805, filed on Oct. 7, 2010.

(51) Int. Cl. G09G 5/00

(52) U.S. Cl. 345/659

(57) ABSTRACT

A power distribution unit with voltage and current sensors and a display which displays inverted characters when the power distribution unit upside down as sensed by a tilt sensor.

### CROSS-REFERENCE TO RELATED APPLICATION

This application claims the benefit of priority under 35§119(e) to U.S. Provisional Patent Application No. 61/390,805 filed Oct. 7, 2010, which is hereby incorporated by reference in its entirety herein.

### BACKGROUND

The invention relates to Power Distribution Units (“PDUs”), and more particularly relates to the displays on PDUs. In one or more specific applications, the invention relates to the orientation of a display on a PDU.

IT equipment rooms (also known as data centers) utilize hundreds or even thousands of separate units of IT equipment, such as servers, switches, and routers. These units are typically mounted on racks. Each unit of IT equipment typically receives power from of a rack mounted power distribution unit (“PDU”). A PDU has multiple appliance outlets designed to distribute electric power within a rack. PDUs are used for taking the supplied voltage and current and distributing it electrically to more common outlets, for example from 240 V 30 A single phase to multiple 120 V 15 A or 120 V 20 A plugs. Rack-PDUs can be dumb—meaning that they have no instrumentation and are not manageable, or they can be metered—meaning that they are equipped with a display that shows current, voltage or power drawn for each outlet. PDUs typically look like a very large “power strip” and are not mounted in the rack like servers but mounted at the back of the rack in various orientations. In such mounting, the orientation of the PDU has one of 4 options. Typically the PDU is mounted vertically. The display is oriented so that the numbers are readable when the PDU is mounted in a vertical orientation. To a technician presented with a PDU at the rear of the rack, trying to read the display, the vertical orientation is legible, and the horizontal orientations are legible by a simple tilt of the head. However, the anti-horizontal orientation is relatively illegible as the displayed numbers will be upside down. As the orientation of the PDU is typically determined by the available space due to servers and cabling in the rear of the rack, and as such sometimes the anti-horizontal orientation is required. Therefore, there remains a need in the art to allow such an anti-horizontal orientation to be legible to a technician.

### SUMMARY OF THE INVENTION

In one or more specific embodiments further described herein, the present invention provides for a power distribution unit (PDU). The PDU has a power input penetrating said vertical strip enclosure. The PDU has a plurality of power outputs disposed along a face of the length of the strip enclosure. Each among the plurality of power outputs is connectable to a corresponding one of said one or more electrical loads. The plurality of sensors monitors the plurality of power outlets and the power input. The PDU has a CPU coupled to the sensors. The PDU has a display coupled to the CPU disposed on the vertical strip enclosure coupled to the power input and the plurality of power outputs and capable of displaying characters. The PDU has a tilt sensor coupled to the CPU disposed within the enclosure vertical strip enclosure such that when then tilt sensor vertical is along the length of the vertical strip enclosure. The CPU receives the sensor information and selects and displays the sensor information. If the tilt sensor is more than a specified angle off of tilt sensor vertical, the display displays the characters in an inverted orientation.

### BRIEF DESCRIPTION OF THE DRAWINGS

Exemplary and non-limiting embodiments of the invention are illustrated in the Figures. The drawings may not be to scale, various details may be enlarged or reduced for clarity, and the illustrate values of any electrical components are merely exemplary and not limiting.

FIG. 1 shows a power distribution unit (PDU).

FIGS. 2A-2B show the two relevant orientations of a prior-art PDU deployed at the rear of a server rack.

FIG. 3 shows a schematic of one embodiment of the present invention.

FIG. 4 shows the tolerances of a tilt sensor in an embodiment of the present invention.

FIG. 5 shows a flow chart of an embodiment of the present invention.

FIG. 6 shows one embodiment of the present invention wherein the LCD display is inverted.

### DETAILED DESCRIPTION

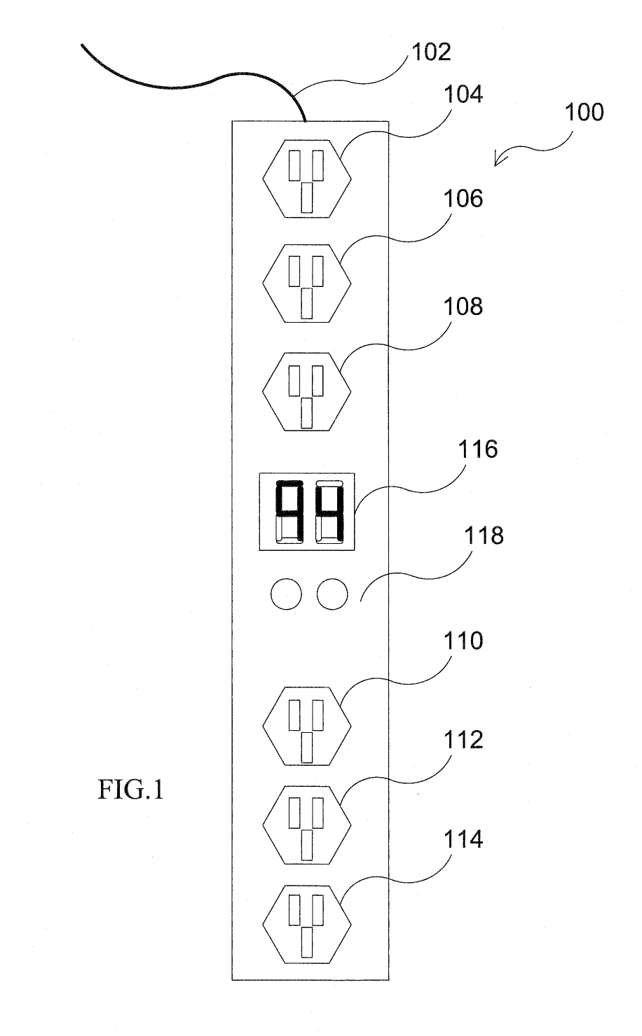

A PDU 100 including a high power inlet 102 from which it receives power (typically from a panel board), multiple lower power outlets 104-114, display 116 and display controls 118. Display 116 is a liquid crystal display (LCD). (FIG. 1) Display controls 118 select from the outlets 104-114 which will have their data displayed, and/or what information to display (current or voltage or power).

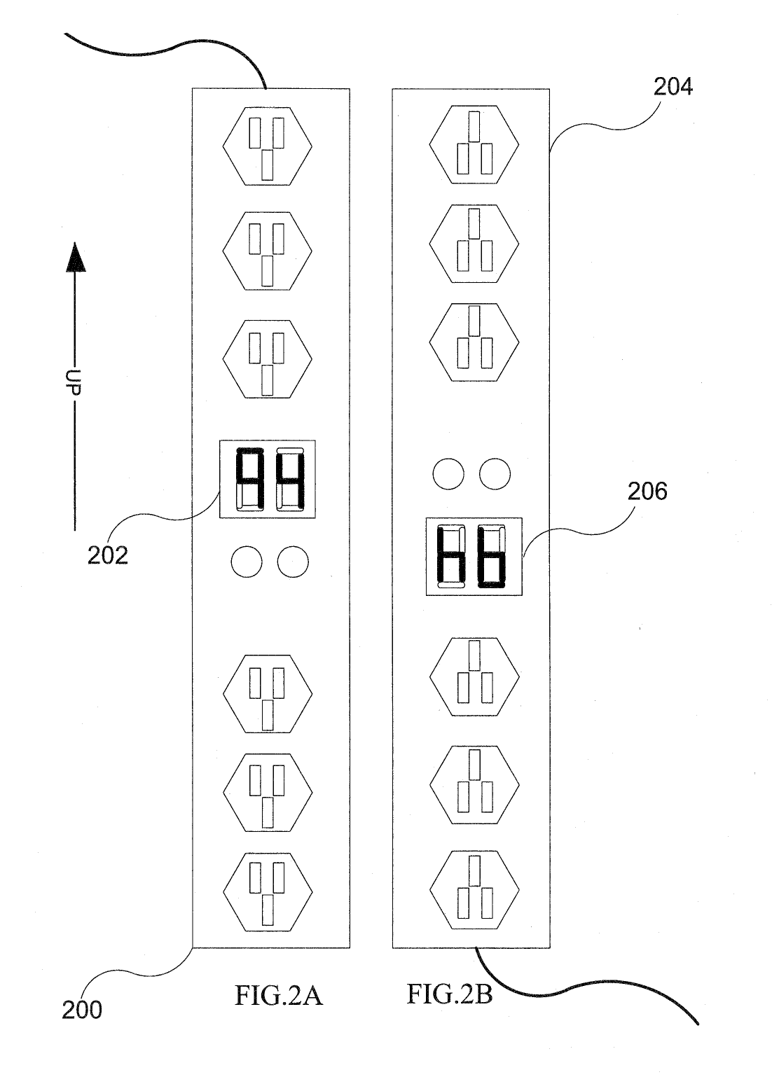

FIGS. 2A-2B shows the possible orientations of a prior art PDU. FIG. 2A shows PDU 200 having display 202 in a vertical orientation. The display 202 displays the number “94”. FIG. 2B shows PDU 204 in anti-vertical (upside down) position. Note that display 206 shows the number “94” upside down.

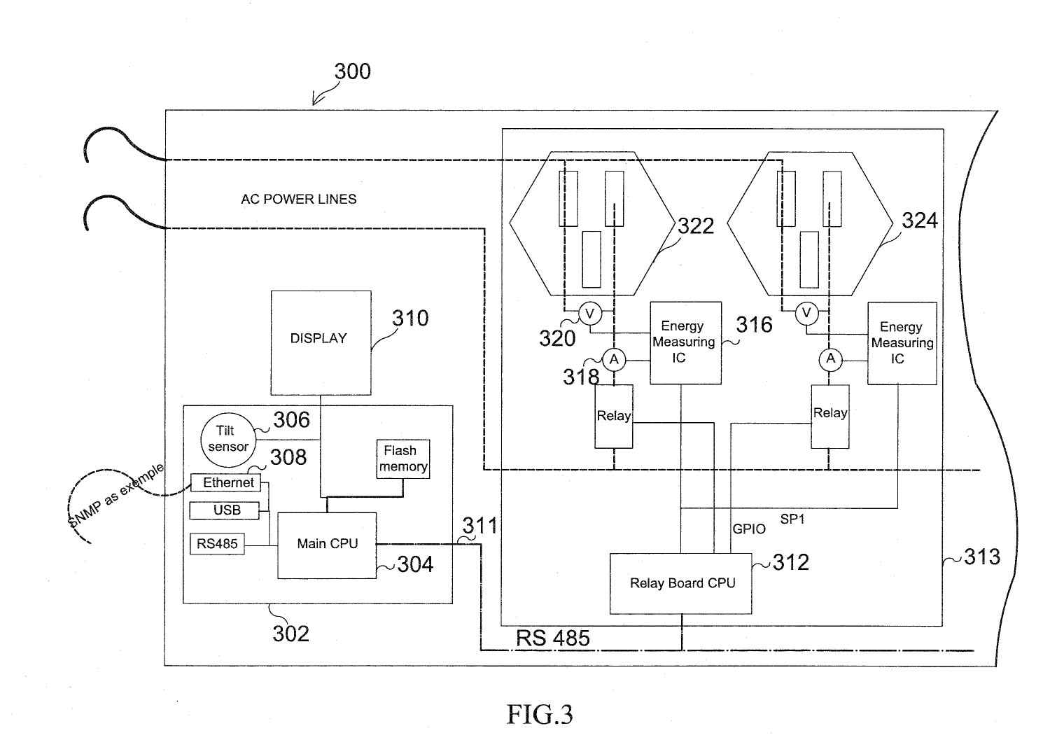

FIG. 3 shows the internals of one embodiment of the present invention. A schematic of a portion of a PDU 200 is shown having a control board 302 on which a CPU 304, a tilt sensor 306, and a communication circuits 308 are mounted. The tilt sensor 306 and a display 310 are each coupled to the CPU 304. The display 310 may be an LCD display. A data bus 311 connects to a relay board CPU 312. This data bus runs the length of the CPU. The data bus connects to circuits on relay board 313. There are multiple relay boards running through the PDU working with groups of outlets like outlets 322 and 324. The relay board CPU 312 is coupled to the energy measuring integrated circuit 316, which in turn coupled to the voltage sensor 320 and the current sensor 318. In operation electricity through the outlet is measured by sensors 318 and 320, which in turn pass the data to the circuit 316 which in turn passes the data to relay board 312 which in turn passes the data to main CPU 304. It is understood that this process is repeated in the other outlets of the PDU. From the many simultaneous measurements the CPU 304 selects which measurement to display and cause the display 310 to display it.

120 Tilt sensor 306 can be one of a variety of tilt sensors Tilt sensors are well known in the art. For example, The SQ-SEN-6xx series tilt sensor acts like a position sensitive switch that is normally open when vertical and normally closed below the switch angle. Gravity determines the vertical. It is designed to be non-sensitive to vibration in the vertical position. When at rest in a vertical position, the sensor will settle in an open state. When tipped down from vertical to the “switch angle” it will produce continuous on/off contact closures while in motion. When at rest below the switch angle, it will settle normally closed. The operation the sensor is described in U.S. Pat. Nos. 7,326,866, 7,067,748, 7,326,867, and 7,421,793. The tilt sensor will send this open or closed signal to the CPU 304.

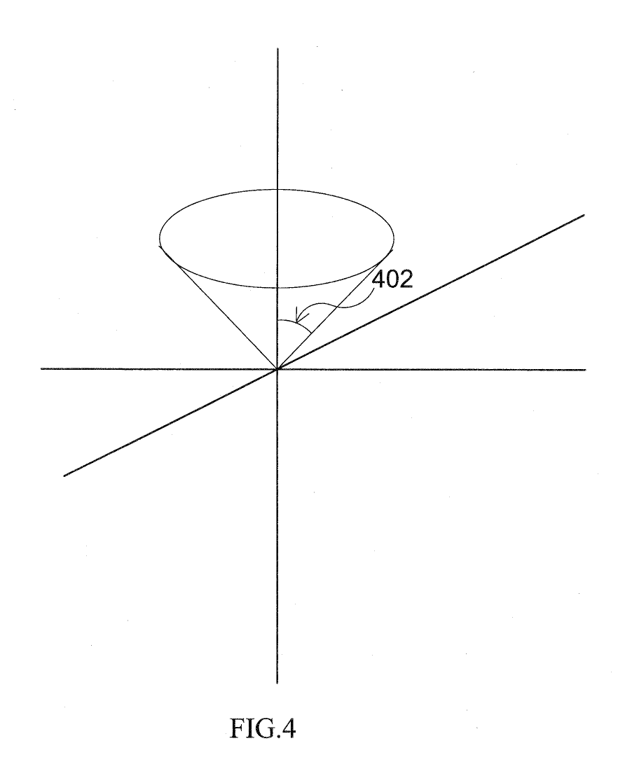

FIG. 4 shows the tolerances of a tilt sensor in one embodiment of the present invention. Angle 402 determines at what point the sensor sends a closed signal. The sensor is available in switch angles of 75°, 60°, 45°. In the preferred embodiment of the present invention, the switch angle is chosen as 60°.

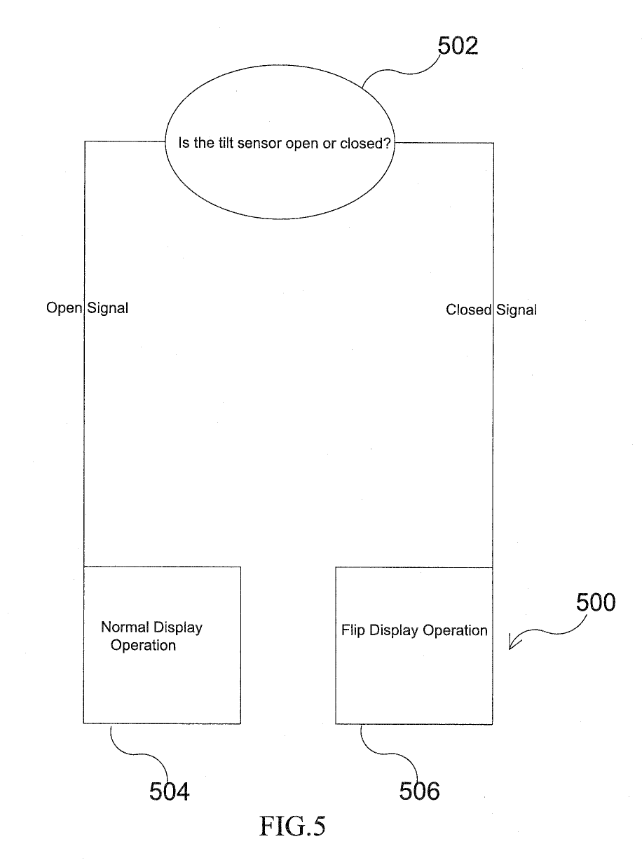

FIG. 5 shows the procedure 500 for using the tilt sensor in one embodiment of the present invention. Step 502 the CPU polls the tilt sensor to see of it is open or closed. If the signal is open then CPU 304 proceeds to step 504. In step 504 the CPU causes the voltage, sensor, or power measurements to be displayed without alteration. If the signal is closed the CPU 304 will proceed to step 506. In step 506 the CPU causes the measurements to be displayed upside down in inverted operation. The CPU will periodically poll the tilt sensor to monitor the PDU orientation.

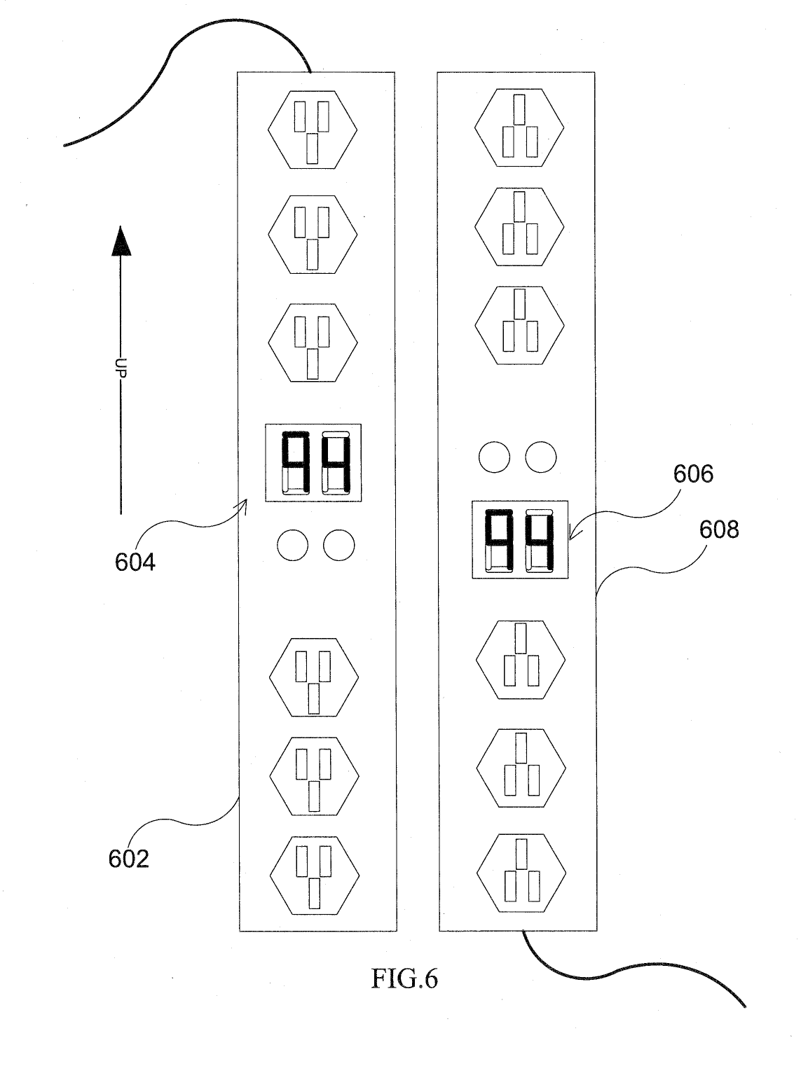

FIG. 6 shows an embodiment of the present invention. PDU 602 is in the vertical position and shows display 604 is the standard way. PDU 606 is shown in an anti-vertical position but the LCD display 608 display the measurement right side up.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A power distribution unit, comprising:
a) a vertical strip enclosure having a thickness and a length longer than a width of the enclosure;
b) a power input penetrating said vertical strip enclosure;
c) a plurality of power outputs disposed along a face of said length of the strip enclosure, each among the plurality of power outputs being connectable to a corresponding one of said one or more electrical loads;
d) a plurality of sensors monitoring said plurality of power outlets and the power input;
e) a cpu coupled to the sensors;
e) a display coupled to the CPU disposed on said vertical strip enclosure coupled to the at least one among the power input and the plurality of power outputs and capable of displaying characters,
f) a tilt sensor coupled to the CPU disposed within said enclosure vertical strip enclosure such that when then tilt sensor vertical is along the length of said vertical strip enclosure; wherein said tilt sensor is in coupled to the CPU;
g) wherein the sensors send sensor information to the CPU which the CPU selects and displays on the display; and
h) wherein if the tilt sensor is more than a specified angle off of tilt sensor vertical, the CPU causes the display displays the characters in an inverted orientation.

2. The power distribution unit of claim 1, wherein the information display is a liquid crystal display.

3. The power distribution unit of claim 1, wherein the specified angle is 60°.

4. The power distribution unit of claim 1, wherein the sensors are selected from the group consisting of voltage and current sensors.

5. The power distribution unit of claim 1, where the CPU polls either an open or a closed indicator from the tilt sensor which indicates if the tilt sensor the display is to be inverted.
